(19) United States
(12) Patent Application Publication
(10) Pub. No.: US 2003/0214809 A1
(43) Pub. Date: Nov. 20, 2003

(54) Colorful rope light

(76) Inventor: Tsui-Tuan Wong, Hong Kong City (CN)

Correspondence Address: Stephen R. Seccombe, Sheldon & Mak, 9th Floor, 225 South Lake Avenue, Pasadena, CA, 91101, US

(21) Appl. No.: 10/306,869

(22) Filed: Nov. 27, 2002

Related U.S. Application Data
(63) Continuation-in-part of application No. 09/933,251, filed on Aug. 20, 2001, now Pat. No. 6,595,659.

(51) Int. Cl. F21V 9/00

(52) U.S. Cl. 362/249; 362/231; 362/250

(57) ABSTRACT

A colorful rope light characterized by colored transparent cladding interposed between a lighted core and an extruded clear cover. The cladding can include selected lengths of tubing, including shrink tubing and longitudinally slit tubing, as well as wrapped strips of transparent colored material. The cladding can also be provided with various color patterns. One or more units of the rope light can each have multiply colored portions, facilitating a wide variety of effects.

### RELATED APPLICATION

This application is a continuation-in-part of application Ser. No. 09/933,251, filed on Aug. 20, 2001, now U.S. Pat. No. ______, which is incorporated herein by this reference.

### BACKGROUND

The present invention relates to decorative lights, and more particularly to colorful rope lights that provide fancy decorations.

Decorative lights having a plurality of bulbs arranged in a length of a flexible core are known. Typically, the flexible core is directly covered with a transparent outer covering that is either colorless or monocolor. Typically, colored rope lights of the prior art are made by first extruding the conductor core, stuffing the light bulbs on the core, and then extruding the finished products with a colored transparent plastic exterior coat. Each rope light therefore has a singular color. The monotony or lack of color variety degrades the decorative value such lights may provide. If it is desired to join multiple colors or to form advertising light patterns, then it is necessary to use connectors to join plural segments of lights having different colors. But using connectors to obtain multiple colors severely restricts the layout of the combination, such that desired integral patterns of advertising designs are impractical or impossible to achieve.

Thus there is a need for a decorative rope light that can have multiple colors without the need for connectors in between the colors, that is versatile, convenient, facilitating improved decorative effects, and that is inexpensive to provide, thereby avoiding or mitigating the disadvantages of the prior art.

### SUMMARY

The present invention meets this need by providing a decorative light that is particularly easy to configure with fancy coloring. The rope light of this invention is formed of a conductor core, non-colored clear bulbs, a colorless clear outer plastic coat, and a colored transparent middle layer. The non-colored bulbs are connected to the conductor core, and a layer of colored, light transmitting plastic layer or other colored light transmitting materials is placed on top of the assembled core. The entire combination is then further coated with colorless top coat of plastic by extrusion. In one aspect of the invention, a colorful decorative light includes a body having a length of flexible core, mini-bulbs and wires electrically connecting the mini-bulbs; a substantially transparent outer covering encasing the body; and a colorful and transparent cladding interposed between the body and the outer covering. The cladding can be formed as a coating of color paint, colored strip(s) wound around the body, and/or colored sleeves (21) mounted around the body.

The colorful light as claimed in claim 1, further comprising at least one intermediate electrical connector mechanically and electrically connecting respective axially disposed units of the decorative light.

A front electrical connector can be mounted to one end of the decorative light for powering same, and a back plug can be mounted to the opposite end of the light.

In another aspect of the invention, a colorful rope light includes a lamp body, a front end connector, and a rear plug, the lamp body having a flexible core, strands of clear light bulbs, a colorless transparent outer coat, and a layer comprising a colored light transmitting material, wherein the core is covered by a colored light transmitting material; and the transparent outer coat is extruded over the light transmitting material. The colored light transmitting material of the layer can be a plastic, which can be formed as longitudinally slit tubing that has snap engagement over the conductor core, being preferably compressed onto the conductor core by the extruded outer coat.

Alternatively, or in addition, the colored light transmitting material of the layer can form heat-shrinkable tubing that is irradiated for close conformance on the conductor core and being preferably compressed onto the conductor core by the extruded outer coat.

An electrical plug can be molded on one end of the lamp body, and an end plug can be molded on the opposite end of the lamp body.

In a further aspect of the invention, a method for making a colorful rope light includes providing a lamp body having a flexible core, and strands of electrically connected clear light bulbs; covering the body with a colored light transmitting material; and extruding a transparent outer covering over the colored light transmitting material. The method can include providing longitudinally slit tubing for the colored light transmitting material, opening the tubing, laterally displacing the tubing over the body, and closing the tubing onto the body. The method can include providing shrinkable tubing for the colored light transmitting material, longitudinally feeding the body into the tubing, and heating the tubing for shrinking the tubing onto the body. The method can also include molding electrical connectors onto opposite ends of the combined lamp body, the colored light transmitting material, and the outer covering.

### DRAWINGS

These and other features, aspects, and advantages of the present invention will become better understood with reference to the following description, appended claims, and accompanying drawings, where:

FIG. 1 is a fragmentary perspective view of a colorful decorative rope light according to the present invention; and

FIG. 2 is a detail side sectional view of a body portion of the rope light of FIG. 1;

FIG. 3 is a fragmentary view of an embodiment of the rope light of FIG. 1 having a series of units;

FIG. 4 is a detail partially sectional view showing alternative cladding configurations of the rope light of FIG. 1;

FIG. 5 is a detail view showing an optional cladding color pattern of the rope light of FIG. 1;

FIG. 6 is a detail view as in FIG. 5, showing another optional cladding color pattern;

FIG. 7 is a detail sectional view as in FIG. 4, showing an additional cladding configuration;

FIG. 8 is a fragmentary sectional end view showing a further cladding configuration of the rope light of FIG. 1; and

FIG. 9 is a process diagram for producing the rope light of FIGS. 1-8.

### DESCRIPTION

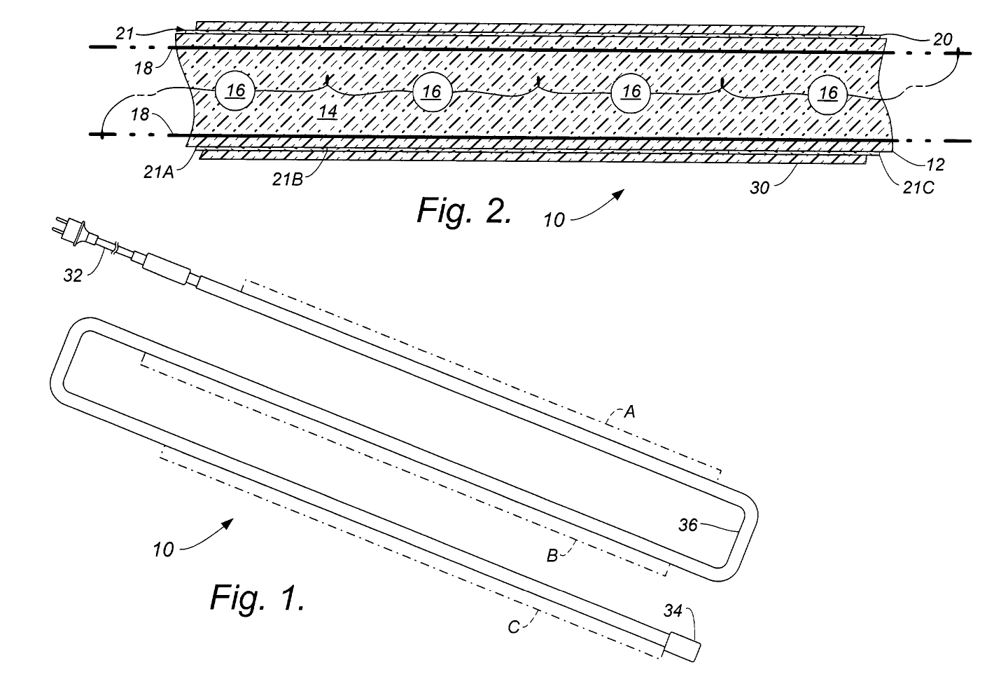

The present invention is directed to a decorative light that is particularly easy to configure with fancy coloring. With reference to FIGS. 1 and 2 of the drawings, a decorative rope light 10 includes a flexible body 12 having a transparent core 14 that is provided with mini-bulbs 16 and wires 18 electrically connecting the bulbs 16, and a substantially transparent outer covering 30 encasing the body 12. A power cord 32 is connected at one end of the wires 18, and a protective cap 34 is provided at an opposite end.

A transparent and colorful cladding 20 is arranged between the body 12 and the outer covering 30. An important feature of the present invention is that the rope light 10 can have differently colored regions A, B, and C in a single unit 36 as indicated in FIG. 1 and further described below. The unit 36 is flexible, being bendable into a desired shape as also indicated in FIG. 1. The cladding 20 can be configured as lengths or segments of sleeves or tubing 21, which can be differently colored as indicated at 21A, 21B, and 21C in FIG. 2.

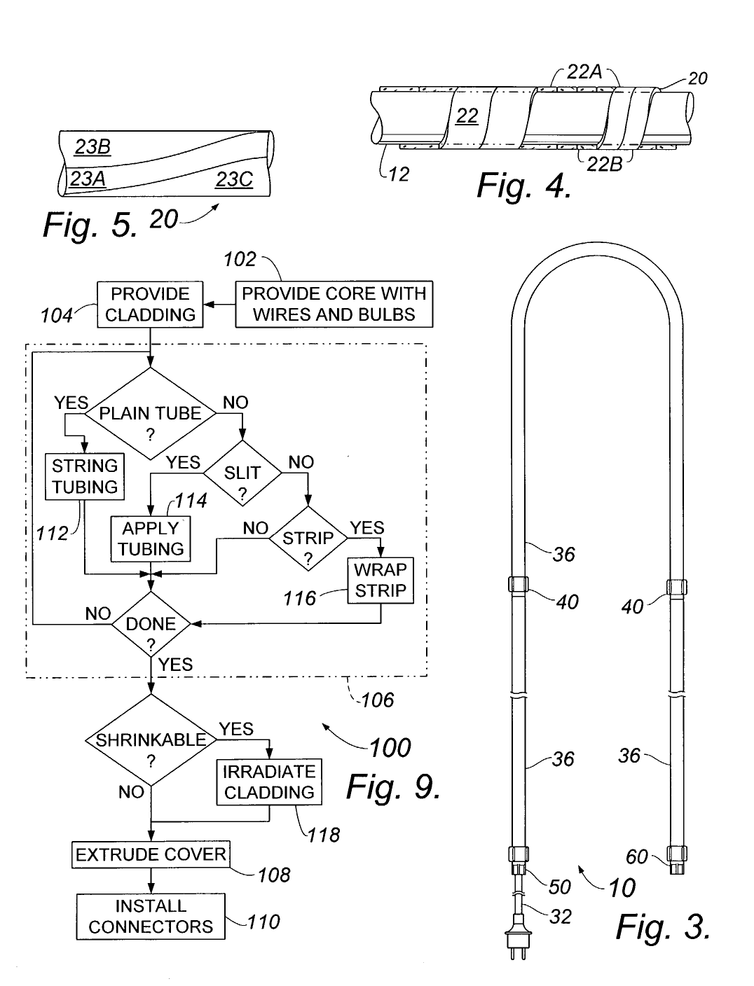

With further reference to FIG. 3, the rope light 10 can include plural units 36 that are interconnected by respective intermediate connectors 40, with a front connector 50 connecting the power cord 32, and a counterpart of the protective cap, designated back plug 60, mounted to the last unit 36.

With further reference to FIG. 4, an alternative configuration of the cladding 20 is formed as spirally wrapped strips. For example, one such strip, designated 22, is wound in edge-to-edge adjacency around a lengthwise portion of the body 12, whereas a pair of strips 22A and 22B, the strips 22 being preferably of different colors, are wound together around another lengthwise portion of the body 12 for providing a spirally striped color pattern.

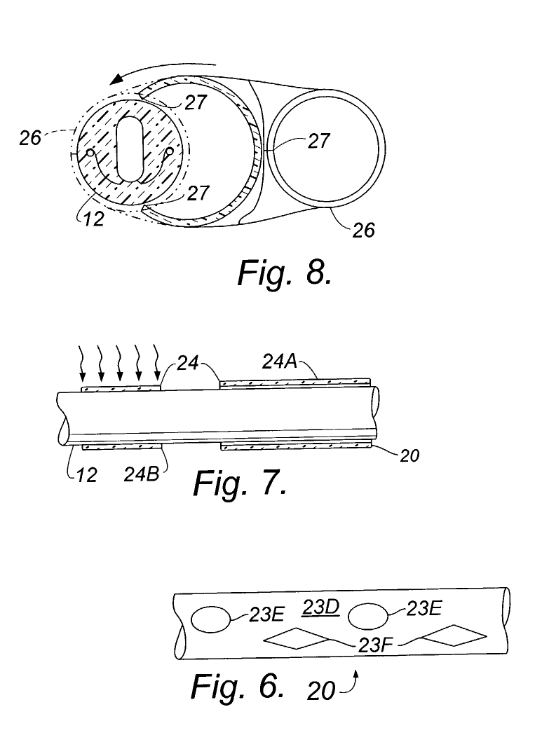

With further reference to FIGS. 5 and 6, the coloring of the cladding 20 can optionally include shaped designs in addition to, or as an alternative to, uniformly colored lengths of the cladding 20. For example, FIG. 5 shows a striped pattern including a first colored region 23A, a second colored region 23B, and a third colored region 23C, the region 23B having a different color than the coloring of the regions 23A and 23C, which also may be the same or differently colored. FIG. 6 shows a repeating pattern including a background region 23D, a first pattern region 23E, and a second pattern region 23F, the pattern regions 23E and 23F being spaced apart and repeating along the cladding 20. It will be understood that the different colorings of the various portions of the cladding 20 can include clear portions. Also, the pattern regions 23E and 23F in FIG. 6 can have the same color but different shapes, the same shapes but different colors, as well as being of the same shape and color. It will be further understood that the shaped designs of FIGS. 5 and 6 apply to the cladding 20 as formed by the tubing 21A, 21B, and 21C of FIG. 2, as well as the strips 22 of FIG. 4.

With further reference to FIG. 7, another alternative configuration of the cladding 20 is formed with heat-shrinkable tubing, designated shrink tubing 24. Advantageously, the shrink tubing 24 is initially has a sufficiently large inside circumference as indicated at 24A to easily be passed onto the body 12, being subsequently radiated with heat for shrinking into closely fitting relation with the core as indicated at 24B in FIG. 7.

With further reference to FIG. 8, yet another alternative configuration of the cladding 20 is formed with longitudinally slit tubing 26. Advantageously, the slit tubing 26 can be temporarily opened as indicated at 27, and snapped or otherwise closed onto the body 12 from the side, facilitating assembly of variant patterns without having to pass the full length of the body 12 through a series of tubing segments, and by permitting rearrangement of the colors (insertion and removal of intermediate segments) during assembly. It will be understood that the opening 27 of the tubing can be accomplished locally while the tubing is laterally moved into position as indicated by the arrow in FIG. 8, with the opening and closing proceeding progressively lengthwise along the tubing 26.

FIG. 9 depicts a process 100 for completing the rope light 10 using any of the various forms of the cladding 20 described above. The process 100 includes the steps of providing the body 12 and assembled mini-bulbs 16 and wires 18 in a provide core step 102; a provide cladding step 104; a load cladding step 106; and heating the combination of the body 12 and the tubing 24A with heat in an irradiate cladding step 106 for shrinking same onto the body 12 as the tubing 24B. Preferably the method further includes extruding the clear outer covering onto the tubing 24B and the body 12 in an extrude cover step 108 for protectively covering same and for providing a smooth outer surface of the rope light 10. The rope light 10 is completed in an install connector step 110 for facilitating external electrical connections, which preferably includes molding the front connector 50 and the back connector 60 in place for enhanced structural integrity and protection from the elements.

In general, the load cladding step 106 includes, when the cladding 20 includes plain tubing being any of the tubing 21 and/or shrink tubing 24, passing one or more lengths of the tubing onto the body 12 in a string tubing step 112, in which lengths of the tubing in selected colors are passed axially onto and positioned as desired on the core 12. Any of the cladding 20 being slit tubing 26 is applied onto the core 12 in an apply tubing step 114, and any of the cladding being strips 22 is applied to the core 12 in a wrap strip step 116. Once at least all of the shrink tubing 24 is in place, and if any is present, the shrink tubing is heated together with the core 12 in an irradiate cladding step 118, prior to the extrude cover step 108.

The rope light of the present invention has the following advantages over existing rope lights: Multiple colors can be displayed on a single strand of rope light, to achieve better decorative and advertising effects. The manufacture of lighted advertising signs, the designer is no longer constrained by the fact that connectors do not allow bending. The ease of bending lowers the material and labor coats, and makes the lighted advertising sign much more lifelike, safer, and with better effects.

Although the present invention has been described in considerable detail with reference to certain preferred versions thereof, other versions are possible. The present invention is of course not limited to only the use of plastics, but can include the use of colored paint or other colored light transmitting materials, within the scope of the present invention. Also, the e colored tubing 21 can be formed by extrusion onto the body 12. Therefore, the spirit and scope of the appended claims should not necessarily be limited to the description of the preferred versions contained herein.

What is claimed is:

1. A colorful decorative light comprising:
(a) a body (12) having a length of flexible core (14) provided with mini-bulbs (16) and wires (18) electrically connecting to the mini-bulbs;
(b) a substantially transparent outer covering (30) encasing the body; and
(c) a colorful and transparent cladding (20) arranged between the body and the outer covering.

2. The colorful decorative light as claimed in claim 1, wherein the cladding is embodied as a coating of color paint.

3. The colorful decorative light as claimed in claim 1, wherein the cladding is embodied as colored strip(s) (22) wound around the body.

4. The colorful light as claimed in claim 1, wherein the cladding is embodied as a plurality of colored sleeves (21) mounted around the body.

5. The colorful light as claimed in claim 1, further comprising at least one intermediate electrical connector mechanically and electrically connecting respective axially disposed units of the decorative light.

6. The colorful light as claimed in claim 1, further comprising a front electrical connector (50) mounted to one end of the decorative light for powering same, and a back plug (60) mounted to the opposite end of the decorative light.

7. A colorful rope light comprising a lamp body, a front end connector, and a rear plug, the lamp body having a flexible core, strands of clear light bulbs, a colorless transparent outer coat, and a layer comprising a colored light transmitting material, characterized in that:
(a) the core is covered by a colored light transmitting material; and
(b) the transparent outer coat is extruded over the light transmitting material.

8. The colorful rope light as claimed in claim 7, wherein the colored light transmitting material of the layer is a plastic.

9. The colorful rope light as claimed in claim 8, further characterized in that the colored light transmitting material of the layer forms longitudinally slit tubing, the tubing having snap engagement over the conductor core, being compressed onto the conductor core by the extruded outer coat.

10. The colorful rope light as claimed in claim 8, further characterized in that the colored light transmitting material of the layer forms heat-shrinkable tubing, the tubing being irradiated for close conformance on the conductor core and being compressed onto the conductor core by the extruded outer coat.

11. The colorful rope light as claimed in claim 7, further characterized in that an electrical plug is molded on one end of the lamp body, and an end plug is molded on the opposite end of the lamp body.

12. A method for making a colorful rope light comprising:
(a) providing a lamp body having a flexible core, and strands of electrically connected clear light bulbs;
(b) covering the body with a colored light transmitting material; and
(c) extruding a transparent outer covering over the colored light transmitting material.

13. The method of claim 12, further comprising providing longitudinally slit tubing for the colored light transmitting material, opening the tubing, laterally displacing the tubing over the body, and closing the tubing onto the body.

14. The method of claim 12, further comprising providing shrinkable tubing for the colored light transmitting material, longitudinally feeding the body into the tubing, and heating the tubing for shrinking the tubing onto the body.

15. The method of claim 12, further comprising molding electrical connectors onto opposite ends of the combined lamp body, the colored light transmitting material, and the outer covering.
